(19) United States
(12) Patent Application Publication
(10) Pub. No.: US 2026/0019375 A1
(43) Pub. Date: Jan. 15, 2026

(54) PROCESSING UNIT, PACKET HANDLING UNIT, ARRANGEMENT AND METHODS FOR HANDLING PACKETS

(71) Applicant: Telefonaktiebolaget LM Ericsson (publ), Stockholm (SE)

(72) Inventors: Amir Roozbeh, Stockholm (SE); Alireza Farshin, Stockholm (SE); Dejan Kostic, Solna (SE); Gerald Q. Maguire, Jr., Stockholm (SE); Chakri Padala, Bangalore (IN)

(21) Appl. No.: 18/993,829

(22) PCT Filed: Jul. 13, 2022
(86) PCT No.: PCT/SE2022/050710

§ 371 Date: Jan. 13, 2025

(51) Int. Cl. H04L 47/6295; H04L 47/22

(52) U.S. Cl. CPC H04L 47/6295; H04L 47/22

(57) ABSTRACT

Embodiments herein disclose for example a method performed by an arrangement (13) for handling packets in a communication network, wherein the arrangement (13) comprises a packet handling unit (10) comprising two or more RX queues and a processing unit (12). The arrangement (13) provides from the packet handling unit (10), an indication to the processing unit (12), wherein the indication indicates a status of a RX queue out of the two or more RX queues; and selects at the processing unit (12) at least one RX queue out of the two or more RX queues to poll one or more packets from based on the provided indication.

### TECHNICAL FIELD

Embodiments herein relate to a processing unit, a packet handling unit, an arrangement and a method performed therein for communication. Furthermore, a computer program product and a computer readable storage medium are also provided herein. In particular, embodiments herein relate to handling packets in a communication network.

### BACKGROUND

An introduction of highspeed links and the need for low-latency Internet services has resulted in fundamental changes in networking equipment such as network interface cards (NIC) and switches. There has been a development of OpenFlow-enabled switches, programmable (P4-enabled) switches, smart NICs, programmable NICs such as Field Programmable Gate Arrays (FPGA), and data processing units (DPU) evolving through the last decade. This equipment offers system developers more programmability and offloading capabilities, enabling them to perform packet processing at different parts of the network. Additionally, modern NICs offer more advanced features such as multi-RX/TX queues, flow steering capabilities, e.g., Receive Side Scaling (RSS), virtualization support, e.g., Single Root input/output Virtualization (SR-IOV), and Transmission Control Protocol/Internet Protocol (TCP/IP) offloading capabilities, e.g., TCP segmentation offload (TSO), Generic Receive Offload (GRO), and Large Receive Offload (LRO), which facilitate deploying low-latency services at multi-hundred-gigabit rates and beyond.

A packet handling unit mentioned herein may be a NIC; however, the packet handling unit may be other input/output (I/O) devices such as Non-Volatile Memory Express (NVMe) drives and graphical processing units (GPU). Below the relevant modules in a NIC are described with reference to FIG. 1. FIG. 1 shows a simplified architecture of a network interface card (NIC).
An “input/output (I/O) Manager” is the main block in a NIC and is responsible for different tasks such as packet classification, packet filtering, scheduling, and queuing. Additionally, it keeps track of the I/O operations such as handling interrupts/polling and updating relevant status registers inside/outside of the NIC.
Physical queues (PQ) in NIC are buffers used to temporarily store incoming packets, called receive (RX) queues, or store the outgoing packets, called transmit (TX) queues. Modern NICs offers multiple queues for RX/TX, each of which is represented by an identity (ID), shown as PQ1, PQ2, . . . , PQN in FIG. 1.
A Direct memory access (DMA) engine block is responsible for transferring packets to and from a computer's memory. It transfers packets from the physical queues to the system memory. In addition, DMA engine can be seen as the communication gateway between the NIC and the system, meaning that most of messages to/from different modules in the NIC are received/sent via DMA engine.

FIG. 2 depicts a ring structure similar to the one used by Data Plane Development Kit (DPDK). While the consumer is reading the packets at the cons_head position, the producer is placing the packets at the prod_head position. The tail positions can be used to prevent consumer and producer from running over each other as the ring is used as a queue data structure. New packet arrival can be observed by noticing the change in the address pointed by the prod_head. This ring buffer is a circular buffer, and the name queue and ring buffer are used interchangeably in this document.

To mitigate the effects of the demise of Dennard scaling and the slowdown of Moore's law, new processors are shipped with more cores, as opposed to higher frequencies. Additionally, the processor vendors are constantly adding new features such as co-processors/accelerators, hardware optimizations, e.g., resource management features for cache/memory management, and new instruction sets, e.g., Streaming Single Instruction, Multiple Data (SIMD) Extensions also referred to as SSE, Advanced Vector Extensions (AVX)-512 and Vector Neural Network Instructions (VNNI).

An SSE3 extension of Intel processors introduced two instructions such as MONITOR and MWAIT, to enable hardware monitoring for an address range. More specifically, the operation system (OS) or kernel may arm the hardware monitoring infrastructure for an address range via MONITOR instruction, and then wait for a store to that specific address, or checking the status of the monitor, via MWAIT instruction. Table 1 shows a brief description of MONITOR instructions in X86 architecture. An application may simply call the following functions:
void_mm_monitor (void const*p, unsigned extensions, unsigned hints)
void_mm_mwait (unsigned extensions, unsigned hints)

To enable user space applications to also benefit from these monitoring capabilities, Intel has introduced three user space variants of these instructions, called UMONITOR, UWAIT, and TPAUSE, which are being included in the newer-generation Intel processors (flagged as WAITPKG) such as Saphire Rapids. Table 1 shows a brief description of UMONITOR instructions in X86 architecture.
void_umonitor (void*a)
unsigned char_umwait (unsigned int ctrl, unsigned_int64 counter)
unsigned char_tpause (unsigned int ctrl, unsigned_int64 counter)

TABLE 1
shows a brief description of MONITOR/UMONITOR
instructions in X86 architecture.

| Opcode | Mnemonic | Description |
|---|---|---|
| 0F 01 C8 | MONITOR | Sets up a linear address |
| | | range to be monitored by |
| | | hardware and activates the |
| | | monitor. The address range |
| | | should be of a write-back |
| | | memory caching type. |
| 0F 01 C9 | MWAIT | A hint that allows the |
| | | processor to stop instruction |
| | | execution and enter an |
| | | implementation-dependent |
| | | optimized state until |
| | | occurrence of a class of |
| | | events; it is architecturally |
| | | identical to a NOP |
| | | instruction. |
| F3 0F AE | UMONITOR | Sets up a linear address |
| | | range to be monitored by |
| | | hardware and activates the |
| | | monitor. The address range |
| | | should be a write-back |
| | | memory caching type. The |
| | | address is contained in |
| | | r16/r32/r64. |
| F2 0F AE | UWAIT | A hint that allows the |
| | | processor to stop instruction |
| | | execution and enter an |
| | | implementation-dependent |
| | | optimized state until |
| | | occurrence of a class of |
| | | events. |
| 66 0F AE | TPAUSE | Directs the processor to |
| | | enter an implementation- |
| | | dependent optimized state |
| | | until the TSC reaches the |
| | | value in EDX:EAX. |

Monitor instructions reports only one event, i.e., changed or unchanged, even when used for an address range; however, many applications may benefit from knowing which part of the address range, e.g., cache line and/or word/byte, has changed. Additionally, the current infrastructure does not enable non-linear address monitoring, i.e., monitoring a set of non-contiguous addresses.

User interrupts is a new feature in Intel Sapphire Rapids, which would allow a device/kernel/another process to interrupt a process in user space. While this allows the device to interrupt user process directly, reducing interrupt latency, it still has to switch between user-level threads, causing cache evictions and introducing jitter in packet processing. These issues could be further exacerbated with multiple queues.

Modern NICs may have a multi RX/TX queue capability. Having multiple queues enables a NIC to interact with multiple central processing unit (CPU) cores, such as physical and logical CPU cores, and to send and/or receive simultaneous traffic to/from the host CPU, improving the packet per second (PPS) and I/O performance. Currently, there are two ways to receive packets from NIC queues: (i) interrupt based and (ii) polling based.

Interrupt based: The standard way to receive packets from an I/O device is via interrupts. Typically, operating systems, e.g., Linux kernel, associate each physical queue at NIC, i.e., a receive (RX) queue, with an interrupt number that can be processed by fixed or different CPU cores. When a packet arrives in a queue and is DMAed to the system memory, the NIC raises an interrupt to the operation system. Then a CPU core starts further processing of the DMAed packet. However, using interrupt imposes overhead and jitter in packet processing when shifting toward faster link speeds.

Polling based: Modern networking applications often use kernel-bypass frameworks, e.g., DPDK, to avoid interrupt-based packet processing overheads. Unlike interrupt-based operating systems, these frameworks actively poll different RX queues at the NIC and ask for packets—they assume that queues will not be empty at higher rates. By doing so, they mitigate the interrupt limitations at high speeds and achieve much higher performance and better latencies at >100-Gbps rates.

To poll each RX queue, the system, i.e., via device driver or poll mode driver, actively checks the status of the RX queue ring, i.e., the I/O operation status in the NIC, e.g., it checks whether the head of the ring, and/or completion queue (CQ) status for a remote direct memory access (RDMA), has changed or not. Upon detecting a change, the system realizes that new packets have been DMAed to the host memory, and it can provide them to the application. Two common ways to check the status of the RX queues are as follows:
1. The poll mode driver constantly reads the status over Peripheral component interconnect express (PCIe), i.e., it sends a PCIe read request to the NIC with a specific offset that represents the status of the I/O operations (e.g., the head of a ring buffer).
2. Upon completion of a successful DMA, the NIC updates, via the DMA, the value of the I/O operation status, e.g., the RX queue ring head, in the host's memory. Consequently, the poll mode driver repeatedly checks the status value in the memory.

From the application perspective, the polling is typically done for more than one packet, i.e., the application asks the poll mode driver up to a certain number of packets, a.k.a. I/O burst size. Therefore, the poll mode driver iteratively repeats one of the aforementioned methods to poll RX queues and/or employs optimization techniques, e.g., multi-packet RX queues and Completion Queue Element (CQE) compression, to receive more packets more efficiently. There might be different implementations/optimizations for realizing polling for different NICs and I/O devices.

Although modern NICs provide a large number of physical queues, e.g., up to 512 RX/TX physical queues in recent NICs, applications, both Linux-based and kernel-bypass, typically limit the number of active queues to the number of available CPU cores that is much smaller than the number of queues, where each RX queue is checked by one CPU core. While it is possible to use more RX/TX queues in the current systems, applications refrain themselves from doing so, as it imposes latency overhead on the application performance due to longer queuing time, less cache locality, and/or extra PCIe overhead. For instance, when a single-core application polls more than one RX queue, it has to inquiry/poll each queue separately in an interactive loop. In each iteration, the CPU core asks the poll mode driver to check one RX queue and then waits for a response. Upon receiving a response, it may immediately go to the next iteration, i.e., polling another RX queue, or it may continue processing the received packets from the current RX queue before continuing to the next iteration. High-performance networking applications usually follow the latter case to batch processing and improve cache locality, i.e., amortizing the cost of running the same instructions on multiple packets, a.k.a. a batch of packets.

There are many advantages in using more queues per core, some of which are as follows:
Modern NICs are shipped with flow steering capabilities that enable applications to define/install rules matching the incoming packets, e.g., using five tuples, on the NIC to distribute them among different queues. Using more queues makes it possible to distribute packets in a more fine-grained way, which could help applications to offload more classification logic into the NIC.
Using one queue per core may result in suboptimal performance. When a single-core CPU core performs layer 2 (L2) forwarding, it can forward packets at ˜120 Gbps with two RX queues, whereas a single RX queue could only achieve ˜90 Gbps. Therefore, devising an efficient way to use more RX queues, without sacrificing latency, could improve the performance of high-performance networking applications.
Each RX queue at the NIC has a limited length, i.e., it can only receive a limited number of descriptors, buffer addresses, from the NIC driver. However, having a higher number of queues and a higher number of descriptors at higher rates, e.g., 200/400 Gbps, could become essential, as the traffic will be more bursty, requiring more buffers at NIC and more descriptors to transfer incoming packets to the system memory. Using more RX queues could solve this problem.

### SUMMARY

As part of developing embodiments herein one or more problems have been identified. Current system's packet handling capabilities do not provide a way to efficiently use multiple queues per core. Associating only one queue to a core wastes computation resources, as some queues receive less traffic, and may be even empty in some conditions. Consequently, the cores responsible for less-popular queues have to perform idle polling, thereby wasting a lot of energy, time, and resources.

Polling multiple RX queues per core could increase throughput, but at the cost of higher latency, especially at multi-hundred-gigabit rates. Polling multiple RX queues needs to be performed in an iterative loop, which requires multiple PCIe transactions and/or multiple memory reads/loads that impose extra latency overhead and uses resources inefficiently.

Current packet handling units do not provide an efficient, such as overhead-free, way to use all the available resources, e.g., rule-based packet steering and queues, on the packet handling unit, as the number of used queues is equal to the number of cores, i.e., significantly smaller than the number of available queues.

The available polling techniques cannot prioritize different queues and current networking infrastructure does not provide a way to probe multiple queues and perform selective polling. Therefore, applications have to poll all queues independently, even the queues receiving low-priority and/or less traffic.

An object of embodiments herein is to provide an efficient way of handling packets in a communication network.

According to an aspect the object may be achieved by a method performed by an arrangement for handling packets in a communication network. The arrangement comprises a packet handling unit, such as a NIC, comprising two or more RX queues and a processing unit, such as a core unit, CPU or similar. The packet handling unit provides an indication to the processing unit, wherein the indication indicates a status of a RX queue out of the two or more RX queues. The processing unit selects at least one RX queue out of the two or more RX queues to poll one or more packets from based on the provided indication.

According to another aspect the object may be achieved by a method performed by a processing unit, such as a single core processing unit, a multicore processing unit, CPU or similar, for handling packets in a communication network. The processing unit obtains an indication from a packet handling unit, such as a NIC, comprising two or more RX queues. The indication indicates a status of a RX queue out of the two or more RX queues. The processing unit further selects at least one RX queue out of the two or more RX queues to poll one or more packets from based on the provided indication.

According to still another aspect the object may be achieved by a method performed by a packet handling unit, such as a NIC, comprising two or more RX queues for handling packets in a communication network. The packet handling unit provides an indication to a processing unit, wherein the indication indicates a status of a RX queue out of the two or more RX queues.

It is furthermore provided herein a computer program product comprising instructions, which, when executed on at least one processor, cause the at least one processor to carry out any of the methods herein, as performed by the arrangement, the packet handling unit, the processing unit, respectively. It is additionally provided herein a computer-readable storage medium, having stored thereon a computer program product comprising instructions which, when executed on at least one processor, cause the at least one processor to carry out any of the methods herein, as performed by the arrangement, the packet handling unit, the processing unit, respectively.

According to yet another aspect the object may be achieved by providing an arrangement for handling packets in a communication network. The arrangement comprises a packet handling unit, such as a NIC, comprising two or more RX queues and a processing unit, such as a multicore or single core processing unit, a core unit, a CPU or similar. The arrangement is configured to provide an indication to the processing unit, wherein the indication indicates a status of a RX queue out of the two or more RX queues. The arrangement is further configured to select at least one RX queue out of the two or more RX queues to poll one or more packets from based on the provided indication.

According to still another aspect the object may be achieved by providing a processing unit, such as a multicore or single core processing unit, a core unit, or similar, for handling packets in a communication network. The processing unit is configured to obtain an indication from a packet handling unit, such as a NIC, comprising two or more RX queues. The indication indicates a status of a RX queue out of the two or more RX queues. The processing unit is further configured to select at least one RX queue out of the two or more RX queues to poll one or more packets from based on the provided indication.

According to yet still another aspect the object may be achieved by providing a packet handling unit, such as a NIC, comprising two or more RX queues for handling packets in a communication network. The packet handling unit is configured to provide an indication to a processing unit, wherein the indication indicates a status of a RX queue out of the two or more RX queues.

Herein methods are provided to retrieve the status of one or multiple RX queues, and consequently perform selective and/or priority-based polling of packets based on the outcome of probing of the statuses.

Additionally, embodiments herein make it possible to associate multiple RX queues to one core in a more efficient way. For example, a single-core application receiving traffic with different priorities, e.g., high priority traffic such as control plane traffic, and low priority traffic, such as data-plane traffic, may use multiple RX queues and may poll packets from RX queues receiving high-priority traffic more frequently than the other queues. Thus, embodiments herein introduce a technique to check the status of multiple RX queues making it possible to perform priority-based and/or selective polling, i.e., polling some RX queues earlier than others and/or polling only non-empty queues based on the indicated status of respective RX queue. This will lead to an efficient way of handling packets in the communication network.

### BRIEF DESCRIPTION OF THE DRAWINGS

Embodiments will now be described in more detail in relation to the enclosed drawings, in which:

FIG. 1 shows a simplified architecture of a NIC according to prior art;

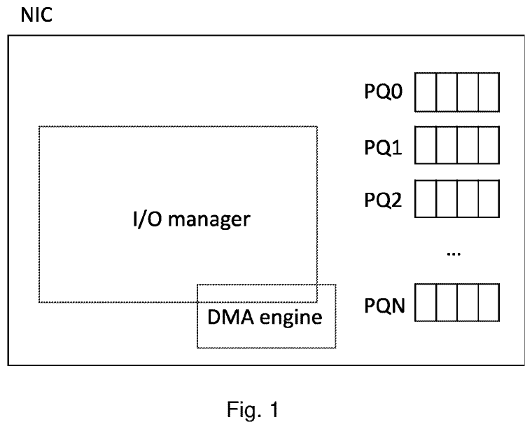

FIG. 2 shows a ring data structure according to prior art;

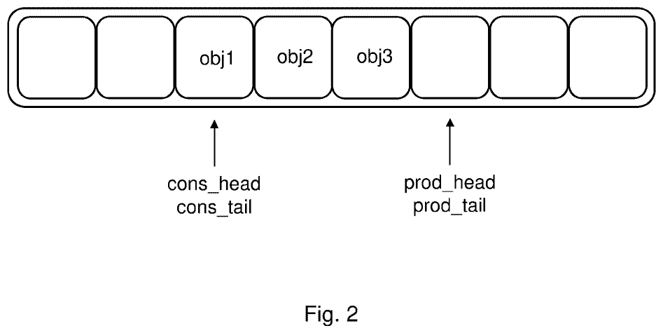

FIG. 3 shows a communication network according to embodiments herein;

FIG. 4 shows a flowchart depicting a method performed by an arrangement according to embodiments herein;

FIG. 5 shows a flowchart depicting a method performed by a packet handling unit according to embodiments herein;

FIG. 6 shows a flowchart depicting a method performed by a processing unit according to embodiments herein;

FIG. 7 shows a high-level overview of the proposed solution (b) as opposed to state-of-the-art (a).

FIG. 8 shows a system overview, wherein gray boxes are proposed in addition to the state-of-the-art;

FIG. 9 shows a H/W realization according to some embodiments herein;

FIG. 10 shows a schematic Packet Event Notification organization;

FIGS. 11a-b show schematic block diagrams depicting an arrangement according to embodiments herein;

FIGS. 12a-b show schematic block diagrams depicting a processing unit according to embodiments herein; and

FIGS. 13a-b show schematic block diagrams depicting a packet handling unit according to embodiments herein.

### DETAILED DESCRIPTION

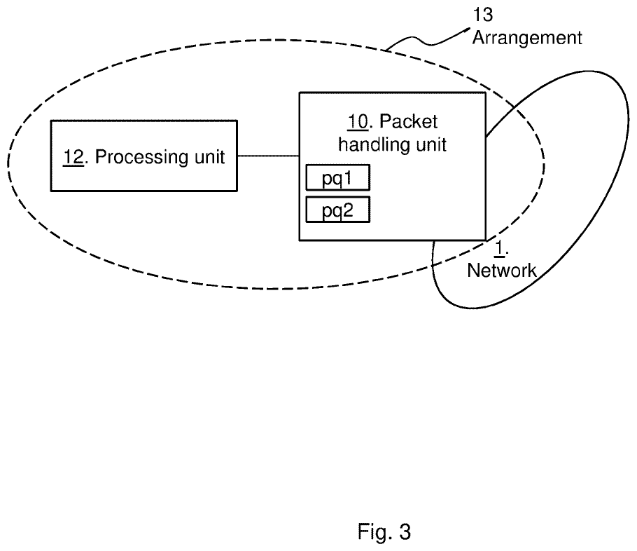

Embodiments herein relate to communication networks in general. FIG. 3 is a schematic overview depicting a communication network 1 handling packet communication, for example, a network associated with a cloud infrastructure. The communication network 1 may comprise one or more access networks, such as radio access networks (RAN) connected to one or more core networks (CN). The communication network 1 may use a number of different technologies, such as an optical network, a wired network, an IP network, a wireless network such as Wi-Fi, Long Term Evolution (LTE), LTE-Advanced, New Radio (NR), Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations.

In the communication network 1, an arrangement 13 comprises a packet handling unit 10 such as a NIC or similar, comprising two or more RX queues such a first queue (pq1) and a second queue (pq2). The arrangement 13 further comprises a processing unit 12 such as a processing unit comprising one or more CPUs, cores or similar. Thus, the processing unit 12 may be a single core processing unit associated with the two or more RX queues, or a multicore processing unit wherein at least one core is associated with the two or more RX queues.

The packet handling unit 10 provides one or more indications to the processing unit 12, wherein the respective indication indicates a status of a respective queue out of the two or more queues. For example, the processing unit 12 may probe the two or more queues for retrieving the one or more indications. The processing unit 12 selects an RX queue to poll packets from based on the one or more indications. The processing unit 12 may then initiate a polling of packets of the selected RX queue.

Embodiments herein disclose methods to enable probing and selective polling in computer systems with multi-queue network devices. More specifically, the concept of queue probing is introduced, where the status of multiple RX queues is checked, and the concept of selective polling that enables an application/user/operating system to poll a (or a set of) queue(s) based on the outcome of probing and the application's/user's preference. Furthermore, two distinct solutions are disclosed in the current systems to realize probing and selective polling in state-of-the-art hardware.

A first solution introduces (i) an extension to recently introduced UMONITOR type of instructions and (ii) methods to use the newly introduced instructions to monitor/check the status of multiple RX queues simultaneously and perform selective/priority-based polling based on the result of the monitoring.

A second solution extends the current processors with a new per-core register that keeps the status of multiple RX queues associated with that core. Additionally, it is herein proposed (i) a table in the I/O device, e.g., NIC, to configure the way by which the per-core register should be updated by the I/O device and (ii) methods for performing selective/priority-based polling using our proposed entities.

Embodiments herein provide a concept of probing and selective polling of one or more multiple RX queues simultaneously. Computer systems are enabled to use more or all the available RX queues on NICs regardless of their number of available CPU cores. Some embodiments herein enable the system to perform priority-based polling among multiple RX queues. Furthermore, embodiments herein further reduce energy consumption by decreasing the number of memory reads required for packet processing.

Embodiments herein make it possible to achieve higher performance (i.e., high throughput and low latency) at high traffic rates such as multi-hundred-gigabit rates.

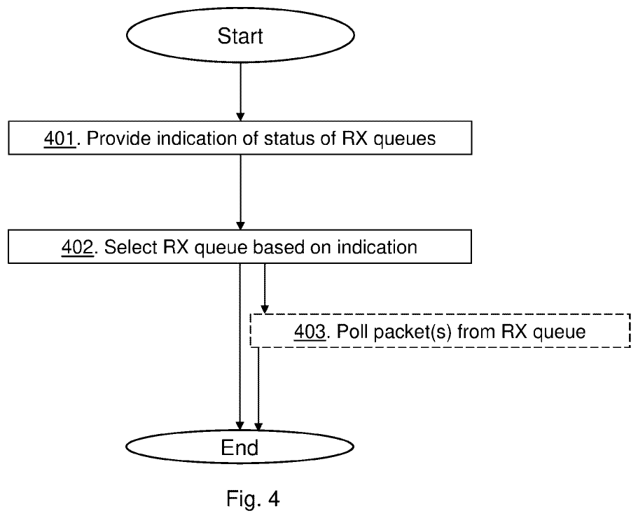

The method actions performed by the arrangement 13 for handling packets in the communication network 1 according to embodiments herein will now be described with reference to a flowchart depicted in FIG. 4. The actions do not have to be taken in the order stated below, but may be taken in any suitable order. Actions performed in some embodiments are marked with dashed boxes. The arrangement 13 comprises the packet handling unit 10 comprising two or more RX queues and the processing unit 12.

Action 401. The arrangement 13 provides from the packet handling unit 10, an indication to the processing unit 12, wherein the indication indicates a status of a RX queue out of the two or more RX queues.

Action 402. The arrangement 13 selects at the processing unit 12 at least one RX queue out of the two or more RX queues to poll one or more packets from based on the provided indication. The processing unit 12 may select a set of, or one or more RX queues.

Action 403. The arrangement 13 may via the processing unit 12 then poll one or more packets from the selected at least one RX queue.

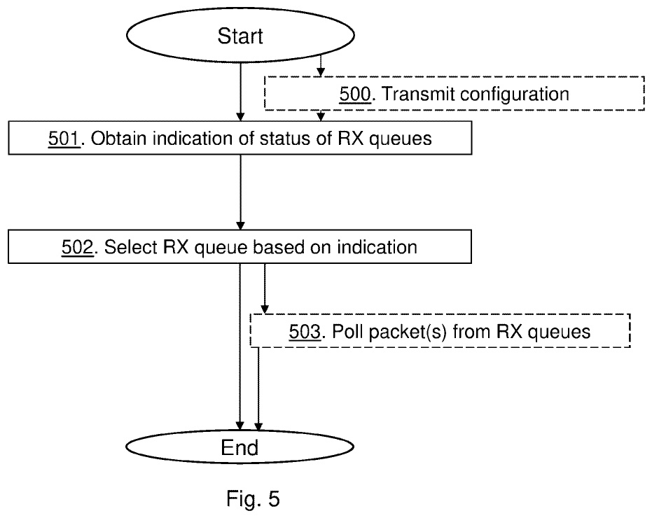

The method actions performed by the processing unit 12 for handling packets in the communication network 1 according to embodiments herein will now be described with reference to a flowchart depicted in FIG. 5. The actions do not have to be taken in the order stated below, but may be taken in any suitable order. Actions performed in some embodiments are marked with dashed boxes. The processing unit 12 may be a single core unit associated with the two or more RX queues, or a multicore processing unit wherein at least one core is associated with the two or more RX queues.

Action 500. The processing unit 12 may transmit, to the packet handling unit 10, a configuration expressing interest in receiving status of two or more RX queues.

Action 501. The processing unit 12 obtains the indication from the packet handling unit 10 comprising the two or more RX queues, wherein the indication indicates a status of a RX queue out of the two or more RX queues. The processing unit 12 may obtain status of a set of RX queues or one or more RX queues. The processing unit 12 may probe the status of the two or more RX queues to obtain the indication. The processing unit 12 may obtain the indication by configuring monitoring instruction or configuring probe register bits (or a table) keeping track of the two or more RX queues associated with one or more processing units at the packet handling unit 10.

Action 502. The processing unit 12 selects at least one RX queue out of the two or more RX queues to poll one or more packets from based on the obtained indication. The processing unit 12 may obtain an indication that a queue is empty and may select another queue to retrieve packet from. The status indicated may indicate availability of packets and/or relevance of packets and the processing unit 12 may select the at least one RX queue based on the availability of packets and/or relevance of packets. Availability may be indicated by a flag, a value or similar. Relevance may be indicated by a value, an index or similar. The processing unit 12 may select the at least one RX queue further based on a preference of an application or user of the application such as based on its priority, i.e., previously defined e.g., by an administrator or it can be selected in a round-robin manner.

Action 503. The processing unit 12 may then poll the one or more packets from the selected at least one RX queue. For example, a few, such as 5, RX queues are configured to receive packets; one of which handles control-plane traffic and the rest receives the data-plane traffic. When the packet handling unit 10 is polled, an indication that Q0 (receiving the control-plane traffic) and Q3 (receiving the data-plane traffic) contains packets, and then the processing unit 12 (or application) decides to first poll Q0 and then Q3.

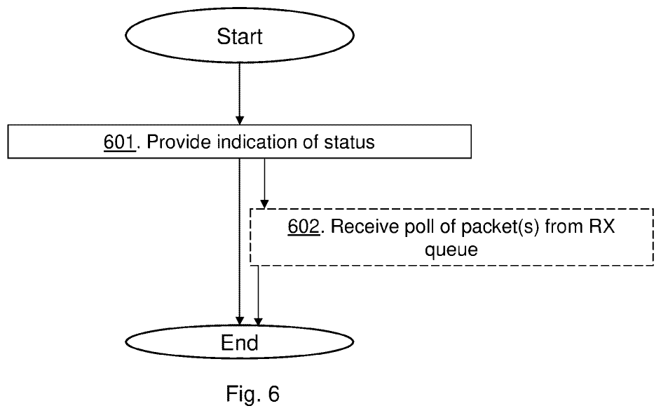

The method actions performed by the packet handling unit 10, such as a NIC, comprising the two or more RX queues for handling packets in the communication network 1 according to embodiments herein will now be described with reference to a flowchart depicted in FIG. 6. The actions do not have to be taken in the order stated below, but may be taken in any suitable order. Actions performed in some embodiments are marked with dashed boxes.

Action 601. The packet handling unit 10 provides the indication, or indications, to the processing unit 12, wherein the indication indicates the status of a RX queue out of the two or more RX queues. Indicating the status may be for initiating a selection at the processing unit 12 of at least one RX queue out of the two or more RX queues to poll one or more packets from based on the provided indication. The status indicated may indicate availability of packets and/or relevance of packets in the RX queue. The packet handling unit 10 may provide the indication by receiving a monitoring instruction or configuring probe register bits (or a table) keeping track of the two or more RX queues associated with one or more processing units at the packet handling unit 10. The packet handling unit 10 may receive a probing from the processing unit 12 retrieving the indication or indications.

Action 602. The packet handling unit 10 may receive from the processing unit 12, the polling of one or more packets from a RX queue.

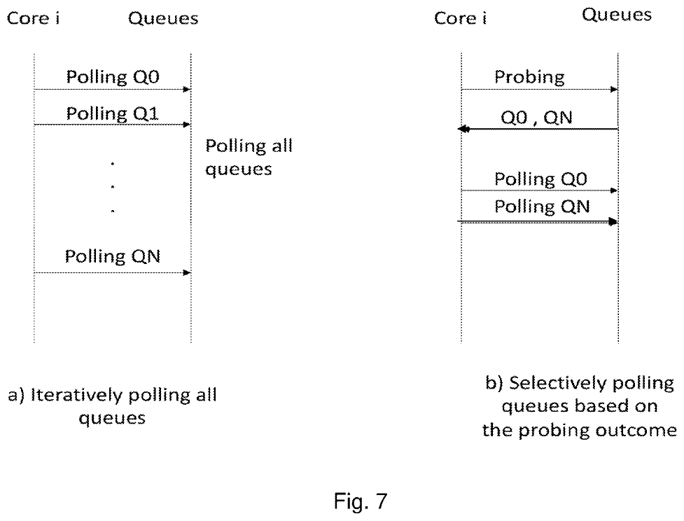

As shown in FIG. 7, our proposed solution enables applications to selectively poll desired queues, e.g., Q0 and QN, based on the outcome of probing and/or application's policy, see b), whereas the state-of-the-art solutions require the applications to poll all queues iteratively (i.e., Q0, Q1, . . . , and PN), see a).

Additionally, embodiments herein make it possible to associate multiple RX queues to one core in a more efficient way. For example, a single-core application receiving traffic with different priorities, e.g., control-plane traffic (high priority) and data-plane traffic (low priority), can use multiple RX queues and polls packets from the RX queues receiving high-priority traffic more frequently than the other queues.

Embodiments herein propose software-dependent methods and further are two hardware-dependent solutions proposed, each of which contains systems and methods. However, the methods herein are not limited to the proposed H/W changes.

### Application-Dependent Methods.

Next, different steps are described that may be done by the user/application/operating system to realize the concept of probing and selective polling according to embodiments herein.

The processing unit 12 such as an application/user/operating system configures the arrangement to receive probing updates from a set of NIC queues, e.g., this step can be done either by configuring monitoring instruction or configuring the probe register bits (register-to-mapping table) available at the packet handling unit 10, see below for details.

The probing updates will be provided to the processing unit 12 from the packet handling unit 10. Each update specifies whether the specified RX queues have performed any successful DMAs or not, e.g., this step can be realized by checking an I/O probe register or relying on the proposed monitoring instruction. This is an example of action 501 in FIG. 5.

The processing unit 12 processes the outcome of the probing and chooses or selects one or some of the RX queues that have successfully DMAed packets. The outcome of probing may be influenced by the policy/priority of the applications/users to achieve higher performance. This is an example of action 502 in FIG. 5.

The processing unit may then reset/re-configure the probing machinery if necessary. For instance, an application may always reset the per-core I/O probe register after reading its value.

The processing unit 12 may then poll the chosen/selected queues according to the probing outcome. This is an example of action 503 in FIG. 5.

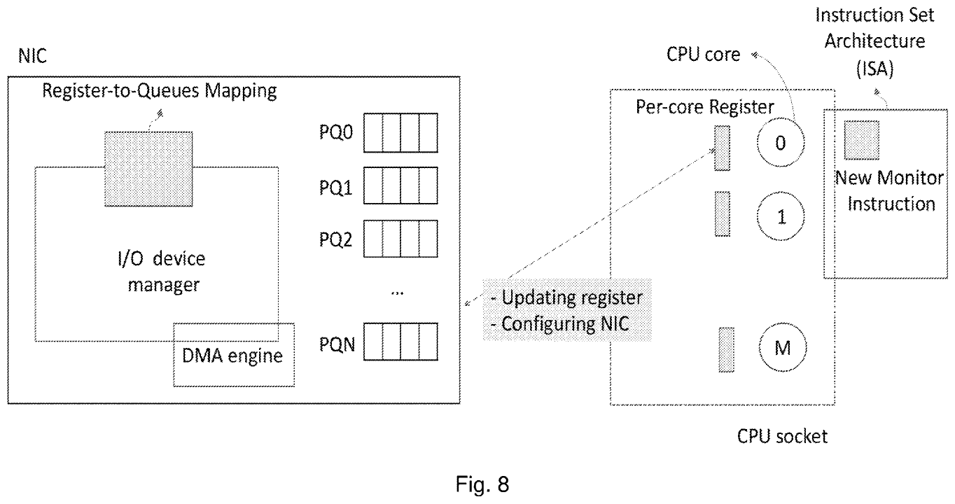

Embodiments herein may further propose two sample implementations for realizing the probing and selective polling according to embodiments herein. FIG. 8 shows modules according to embodiments herein.

Two new instructions or methods may be introduced, called pq_monitor and pq_status, which perform fine-grained monitoring and report the indication such as a bitmask/value representing the portions, i.e., cache line/word/byte, of the address ranges that have been changed (independent solution).

A new per-CPU-core register, called I/O Probe register, may be introduced, which stores the status of multiple RX queues (or I/O events) associated with a CPU core. Depending on the processor generation, this I/O Probe register may be shared with an already available register to save the fabrication cost. For instance, one AVX register in X86_64 architecture, e.g., 512-bit ZMM register, may realize the functionality required by the I/O Probe register. Additionally, it may be possible to realize a similar functionality via in-cache data structure.

The I/O device manager module within a NIC may be extended with a new table/data structure called Register-to-Queue Mapping that keeps track of the RX queues associated with each core. The I/O device manager module uses the information in the table/data structure to update the value of the per-core registers, i.e., I/O Probe registers, upon DMA-ing a packet to the host/CPU memory. Thus, FIG. 8 shows a system overview—the gray boxes are proposed in addition to the state-of-the-art.

Thus, in some embodiments herein the processing unit 12 comprises multicores, wherein each core is associated with two or more RX queues. The processing unit 12 may probe statuses of the two or more RX queues of each core and poll packets from the RX queues based on the probed statuses.

### Monitoring-Based Solution.

Embodiments herein may track multiple ring buffer addresses as well as support for prioritizing a subset of RX queues. Herein it is described the hardware (HW) and infrastructure that may be used to implement this functionality. As the functionality can be broken down into one or more HW instructions, optimizing based on register availability etc., these instructions are not described in terms of assembler instructions or opcodes. It is herein disclosed a hypothetical function that could result in a sequence of instructions/opcodes. The function is described here.
Unsigned int pq_monitor (void*address, int n_address, uint64_t timeout, uint64_t prio_addr_mask, uint64_t prio_timeout).
   To monitor n RX queues the application may invoke the pq_monitor function in hardware, with an array of addresses of size n, where each address points to a prod_head location along with size of the array (‘n’ in this case). The prod_head addresses change after a new packet is DMA′ed to the CPU. It is possible that hardware places reasonable restrictions that ‘n’ cannot be larger than 64 or 128.
   A timeout parameter may indicate a minimum time for which this infrastructure should wait after the arrival of packets in at least 1 ring buffer before notifying the user. Till this timeout happens, the user process is not notified even if the prod_head changes. This allows for notification aggregation for packets across multiple rings. If there are no prod_head changes for the specified timeout duration, the user is notified after the first change happens to at least 1 ring buffer.
   The function may also include additional optional information; a prio_addr_mask and prio_timeout. The prio_addr_mask is a bitmask that represents a subset of the ‘n’ prod_head addresses which are priority packet queues. After a change happens to any of these subset queues/ring buffers, the hardware unit waits for a timeout of prio_timeout. The prio_timeout may be less than timeout to implement lower latency packet queues. This provides a two-level packet latency hierarchy. It is conceivable that instead of just one prio_addr_mask and prio_timeout, more bitmasks and timeouts may be provided to introduce a packet latency hierarchy.

### H/W Realization.

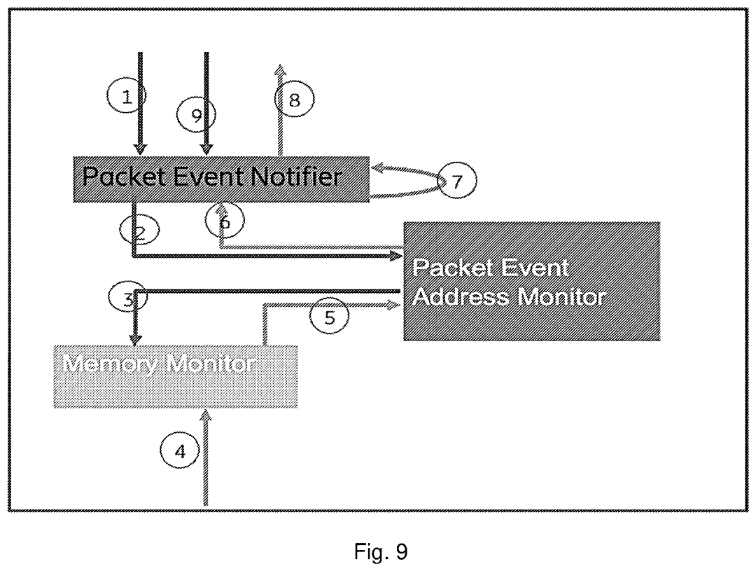

FIG. 9 shows three hardware blocks that are used in our example realization.

1. Packet Event Notifier: Packet event notifier is responsible for
1. Receiving application configuration
2. Configuring other H/W entities
3. Timer configurations
4. User notification/status
   2. Packet Event Address Monitor: Packet event address monitor is responsible for
1. Storing address range information
2. Receiving address modification notification
3. Informing the memory event notifier
   3. Memory Monitor: Memory monitor is an existing H/W entity that is responsible notifying when the content of a specified memory address range changes.
   FIG. 9 shows an example H/W realization of pq_monitor and pq_status.

### In FIG. 9,

Event 1 corresponds to the addition of a new set of packet queues producer index address ranges to the Packet Event Notifier corresponding to the pq_monitor instruction.
Event 8 corresponds to the invocation of user interrupt required for the umwait instruction described above
Event 9 corresponds to the retrieval of bitmask corresponding to the pq_status event.
Event 4 corresponds to the ring buffer prod_head address change event being monitored by the Memory monitor block.

These events and other internal interaction events (2, 3, 5, 6, 7) are further described in the document below.

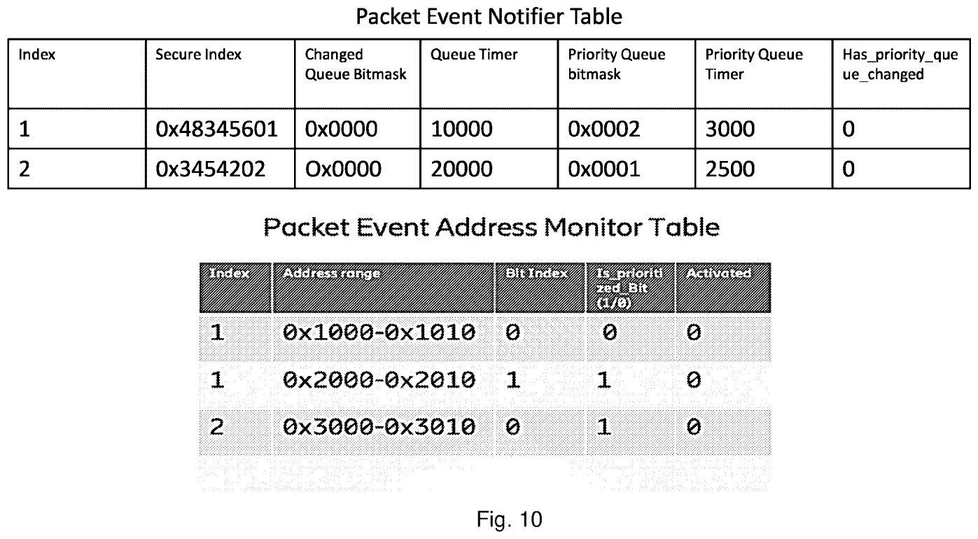

FIG. 10 shows a possible internal data representation of packet event notifier and packet event address monitor hardware.

### Event 1:

In response to a pq_monitor request (Event 1) with 2 addresses 0x1000-0x1010 and 0x2000-0x2010, timeout of 10000 ticks, priority bitmask of 0x0002 (i.e., the second queue 0x2000-0x2010 is a priority queue) and priority timeout of 3000, the following steps will be taken place.
The packet event notifier looks for the first empty slot in its packet event notifier table.
It generates a random number for a secure index (SI). The empty slot number is then stored in the first X bits of the generated secure index. For example, if a random number 0x48345610 is generated and the empty slot is 1, the secure index becomes 0x48345601 assuming X=8 in this case.
It sets the “changed queue Bitmask” to zero for the entry and populates the timer priority bitmask and priority timer with the user specified value. The “priority Bit set” field is subsequently explained. The “changed queue Bitmask” represents the incremental bitmask of queues that changed since the user retrieved this field previously.
Then packet event notifier table (PENT) programs the packet event address monitor table with the following information (Event 2):
   Packet event address monitor contains the following fields:
      Index (corresponds to the field with the same name in PENT),
      Address range that corresponds to the one entry of address provided in the pq_monitor request is provided as part of the pq_monitor,
      Bit index: corresponds to the array index of the address range being specified,
      ls_prioritized_Bit indicates whether this address range belongs to a priority queue, and it has a value 0 or 1,
      Activated indicates whether this address range modification has happened, and it has a value 0 or 1.
   As example: It provisions its own index 1, the first address range 0x1000-1010 along with the bit index of this address (0) and since the queue index is not a priority the prioritized bit is set to 0. The Activated bit which has a value of 0/1 is discussed subsequently.
      For the second address in the request the corresponding entries are added to the packet event address monitor table with the same index but with corresponding address range, bit index and prioritized bit.
Then these addresses (0x1000-1010 and 0x2000-2010) are configured in Memory Monitor HW block. (Event 3)
The packet event notifier then starts 2 timers corresponding to this row, 1 specifically for priority queues and 1 timer for all the queues.
The secure index (SI) is returned to user for future maintenance of this entry.

### Event 4.

When the NIC adds a packet descriptor to the ring_buffer and updates the prod_index,
The Memory monitor detects the memory change notification (Event 4).
This address is then notified to the Packet event address monitor (PEAM).
Packet event address monitor looks up the notified address in its table (PEAM). The table can be realized as a content addressable memory (CAM) enabling a very high-speed lookup. The lookup result gives 3 values: the index, the bit index, prioritized bit and activated.
   If the value of Activated is set (1), then the event from Memory Monitor is ignored. This prevents too many events being reported for the same producer index.
   If the value of Activated is not set (0), then an event is generated to packet event notifier table with the fields: Index of the matched entry, bit index of the entry, the value of prioritized bit is set for this entry (i.e., 1 or 0).
      At this point the Activated bit is set (1) in the corresponding packet event address monitor table entry to prevent further events being notified
      It could also delete the corresponding configuration for this entry from memory monitor block.
   The packet event notifier, upon receiving an event, checks the index and updates the changed queue Bitmask with the bit index from the event. If the “ls_prioritized_bit” is set for the event, has_priority_queue_changed bit is set to 1 for the corresponding index.
      The packet event notifier then checks the status of the timer. If the has_priority_queue_changed bit is set and the priority queue timer is elapsed, then user process is notified by a user interrupt (event 8)
      If has_priority_queue_changed bit is not set but queue_timer is elapsed, then the requesting process is notified by a user interrupt (event 8)

### Event 8.

When timer elapsed event fires (event 7)
If the priority queue timer fires, the has_priority_queue_changed bit is checked. If the bit is set, then the requesting process is notified by a user interrupt (event 8).
   If the has_priority_queue_changed is not set, the timer is expired.
      If the queue_timer fires, the changed queue bitmask is checked. If its value is not zero, then the requesting process is notified by a user interrupt (event 8), otherwise the timer just expires.
      Event 8 can also be fired as specified in Event 4.

### Event 9

The user queries the PENT for the status of the packet queues specified as part of event 1.
This may be performed in response to event 8 or on a periodic basis.
When a process wants to query the list of queues that have changed since the previous query, it does this by sending a secure index.
The secure index is converted/calculated into an index of the PENT by using the lowest X bits as specified in the event 1 handling.
Then the security index corresponding to the calculated index is verified with the one in the table. This prevents unauthorized access to a process's information as unauthorized access leads to clearing of some of the table data as described below.
The changed queue Bitmask is checked, if it is set to zero, nothing is done, a value of zero is returned to the requesting process and the timers are reset and restarted.
If the changed queue bitmask is not zero, the changed_queue_bitmask is returned to the user
   Additionally, the value of changed_queue_bitmask and has_priority_queue_changed are reset to zero
   The timers are restarted
   The corresponding Activated field in packet_event_address_monitor_table (PEAM) is reset (0)
      This causes the corresponding address re-registered with memory monitor H/W.

### The I/O Probe Register.

To realize probing, a register is introduced to keep the statuses, also referred to as states, of the RX queues updated. For better performance reasons, i.e., avoiding PCIe reads, each CPU core may have an I/O probe register, and its value will be updated by the packet handling unit 10. Therefore, a CPU may probe a local register to enquiry about the status of its desirable queues. However, it is possible to move these registers to the packet handling unit 10 to make the solution processor independent. In this case, the packet handling unit 10 should contain a set of per-core registers to make it possible for each core to access them via PCIe transactions.

Each bit of this register is associated with a queue: if set the head of the ring buffer of that queue is updated, i.e., the packet handling unit 10 has successfully transmitted/DMAed a packet belonging to this RX queue to the host's memory. To make it possible to understand consecutive updates, the user/application should reset the value of this register, every time they read it.

Table 2 shows an example of a I/O probe register comprising probe register bits, wherein bit 0, 1, and 2 represents the status of Q0, Q1, and Q3, respectively. In this example, the NIC has set the value of bit 1 (for Q1), meaning it is ready to be polled as it has one successful DMAed packet.

TABLE 2

| — | Q3 | Q1 | Q0 | Queue ID |
|---|---|---|---|---|
| 0 | 0 | 1 | 0 | Bit |

### Register-to-Queue Mapping.

Register-to-Queue mapping is a data structure responsible for keeping the configuration required by the packet handling unit 10 to update the I/O probe registers. A user/application/operating system configures this table according to the packet handling unit vendor guidelines or tools, e.g., ethtool in Linux kernel. They specify their desired RX queues and the I/O probe register, and associated bits to each queue, to which the probing data should be DMA-ed by the packet handling unit 10. Table 3 shows an example of the Register-to-Queue Mapping table where core 0 has requested the packet handling unit 10 to update (set to 1) the bit 0, 1, 2 of I/O probe register of core 0 whenever Q0, Q1, and Q3 receives any packet. This table requires at least 4 columns, as follows:

Queue ID: this field shows the identifier for each queue. We assume that the initial table contains an entry for every available queue in the packet handling unit 10. However, it is possible to adaptively optimize the length of this table based on the available memory on the packet handling unit 10.

Probe Register enabled (EN): This column specifies whether the status of this queue will be probed by the host or not. If set (true/1), the packet handling unit 10 will set the value of the specified bit to the designated core's register/in-cache memory whenever the head of the ring buffer changes, i.e., the packet handling unit 10 successfully DMAs a packet to the host for this specific queue.

Probe Register bit: This column specifies the bit in the register. In cases where a system uses in-cache memory addresses for probing, this field could represent larger values, e.g., a byte/word, to address false sharing and avoid unnecessary cache-line updates.

Core ID (or register/in-cache address): This field shows the core ID to which the status of the queue should be DMAed. The status of each RX queue may be probed by one core at a time; therefore, this field only contains one value. However, it is possible to easily extend this to connect each RX queue to multiple registers. In cases where a system uses in-cache memory addresses rather than I/O probe registers, this field will contain the address of the data structure.

TABLE 3

| Queue | Probe register | Probe | Core ID (or register/ |
|---|---|---|---|
| ID | enabled (0 or 1) | register bit | in-cache address) |
| Q0 | 1 | 0 | 0 |
| Q1 | 1 | 1 | 0 |
| Q2 | 0 | — | — |
| Q3 | 1 | 2 | 0 |
| Q4 | 0 | — | — |
| . . . | . . . | . . . | . . . |
| QN | 0 | — | — |

Use cases.

In addition to the previously mentioned advantages for generic applications, embodiments herein may bring additional benefits to some specific applications/uses cases.

Mixed priority traffic: There are many networking applications that receive traffic with different priorities, e.g., control and data traffic and/or short/long flows. Embodiments herein enable these applications to give higher priority to the RX queues receiving high-priority traffic, even when the system/network is congested, by employing the proposed probing/selective polling technique.

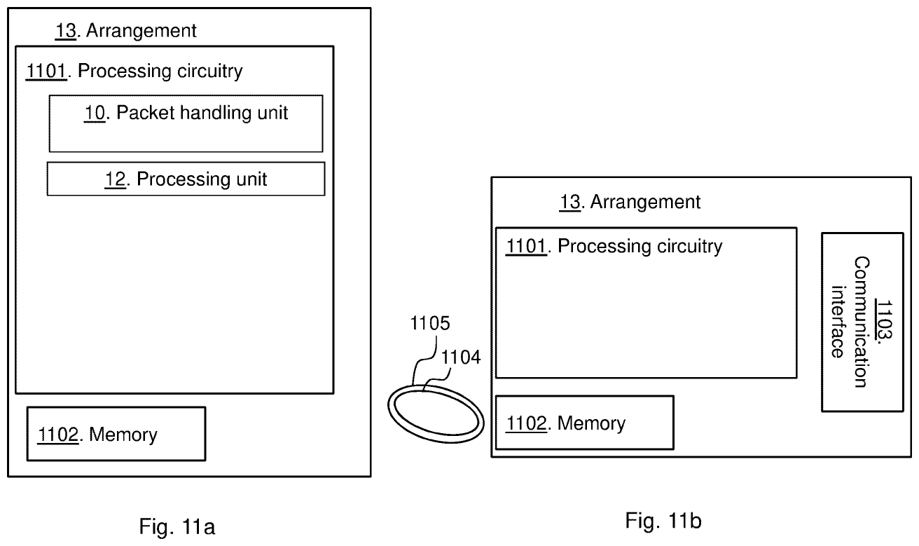

FIGS. 11a-11b are schematic overview depicting the arrangement 13 for handling packets in the communication network, wherein the arrangement 13 comprises the packet handling unit 10 comprising two or more RX queues and the processing unit 12 according to embodiments herein.

The arrangement 13 may comprise processing circuitry 1101, such as one or more processors, configured to perform methods herein. The processing circuitry 1101 may be arranged in one stand-alone unit or be distributed among a number of servers or units.

The arrangement 13, the processing circuitry 1101, and/or the packet handling unit 10 is configured to provide from the packet handling unit 10, the indication to the processing unit 12, wherein the indication indicates the status of a RX queue out of the two or more RX queues.

The arrangement 13, the processing circuitry 1101, and/or the processing unit 12 is configured to select at the processing unit 12 at least one RX queue out of the two or more RX queues to poll one or more packets from based on the provided indication.

The arrangement 13 comprises a memory 1102. The memory 1102 comprises one or more units to be used to store data on, such as indications, status information, packets, actions, resource information, data related to nodes, and applications to perform the methods disclosed herein when being executed, and similar. Thus, embodiments herein may disclose an arrangement 13 for handling packets in the communication network, wherein the arrangement 13 comprises the packet handling unit 10 comprising two or more RX queues and the processing unit 12, wherein the arrangement 13 comprises processing circuitry and a memory, said memory comprising instructions executable by said processing circuitry whereby said arrangement is operative to perform any of the methods herein. Furthermore, the arrangement 13 may comprise a communication interface 1103 comprising, e.g., a transmitter, a receiver and/or a transceiver.

The methods according to the embodiments described herein for the arrangement 13 are respectively implemented by means of e.g. a computer program product 1104 or a computer program, comprising instructions, i.e., software code portions, which, when executed on at least one processor, cause the at least one processor to carry out the actions described herein, as performed by the arrangement. The computer program product 1104 may be stored on a computer-readable storage medium 1105, e.g., a disc, a universal serial bus (USB) stick or similar. The computer-readable storage medium 1105, having stored thereon the computer program product, may comprise the instructions which, when executed on at least one processor, cause the at least one processor to carry out the actions described herein, as performed by the arrangement 13. In some embodiments, the computer-readable storage medium may be a transitory or a non-transitory computer-readable storage medium.

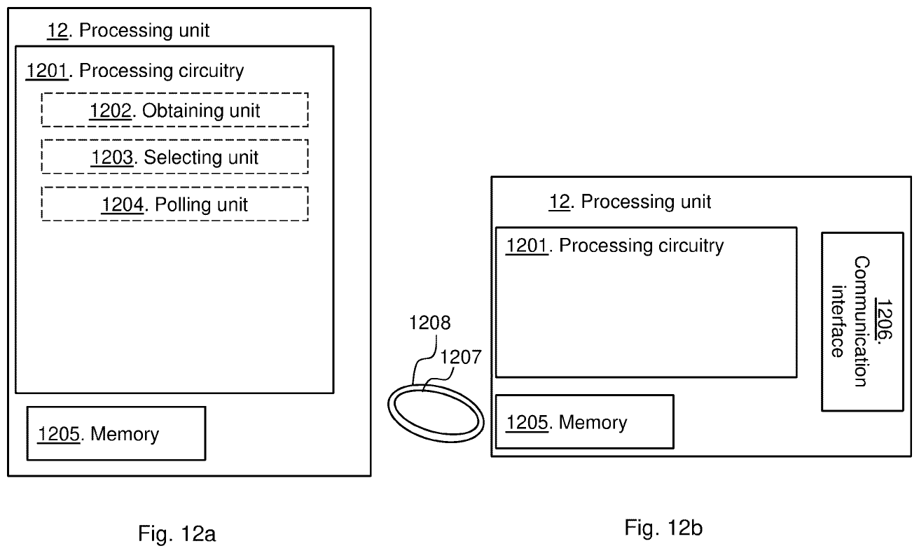

FIGS. 12a-b are schematic overviews of the processing unit 12 for handling packets in the communication network according to embodiments herein.

The processing unit 12 may comprise processing circuitry 1201, e.g. one or more processors, configured to perform the methods herein. The processing circuitry 1201 may be arranged in one stand-alone unit or be distributed among a number of servers or units.

The processing unit 12 may comprise an obtaining unit 1202, e.g., a reader, a prober, a receiver or transceiver. The processing unit 12, the processing circuitry 1201, and/or the obtaining unit 1202 is configured to obtain the indication from the packet handling unit 10 comprising two or more RX queues, wherein the indication indicates the status of the RX queue out of the two or more RX queues. The processing unit 12, the processing circuitry 1201, and/or the obtaining unit 1202 may be configured to obtain the indication by probing the status of the two or more RX queues. The processing unit 12, the processing circuitry 1201, and/or the obtaining unit 1202 may be configured to obtain the indication by configuring the monitoring instruction or configuring the probe register bits keeping track of the two or more RX queues associated with one or more processing units at the packet handling unit, such as an I/O probe table.

The processing unit 12 may comprise a selecting unit 1203, e.g., a selector. The processing unit 12, the processing circuitry 1201, and/or the selecting unit 1203 is configured to select the at least one RX queue out of the two or more RX queues to poll one or more packets from based on the obtained indication. The status indicated may indicate availability of packets and/or relevance of packets, and wherein the processing unit 12, the processing circuitry 1201, and/or the selecting unit 1203 may be configured to select the at least one RX queue based on the availability of packets and/or relevance of packets. The processing unit 12, the processing circuitry 1201, and/or the selecting unit 1203 may be configured to select the at least one RX queue further based on a preference of an application or user of the application.

The processing unit 12 may comprise a polling unit 1204. The processing unit 12, the processing circuitry 1201, and/or the polling unit 1204 may be configured to poll the one or more packets from the selected at least one RX queue.

The processing unit 12 comprises a memory 1205. The memory 1205 comprises one or more units to be used to store data on, such as indications, status information, packets, actions, resource information, data related to nodes, and applications to perform the methods disclosed herein when being executed, and similar. Thus, embodiments herein may disclose a processing unit 12 for handling packets in the communication network, wherein the processing unit 12 comprises processing circuitry and a memory, said memory comprising instructions executable by said processing circuitry whereby said processing unit 12 is operative to perform any of the methods herein. Furthermore, the processing unit 12 may comprise a communication interface 1206 comprising, e.g., a transmitter, a receiver and/or a transceiver.

The methods according to the embodiments described herein for the processing unit 12 are respectively implemented by means of e.g. a computer program product 1207 or a computer program, comprising instructions, i.e., software code portions, which, when executed on at least one processor, cause the at least one processor to carry out the actions described herein, as performed by the processing unit 12. The computer program product 1207 may be stored on a computer-readable storage medium 1208, e.g., a disc, a universal serial bus (USB) stick or similar. The computer-readable storage medium 1208, having stored thereon the computer program product, may comprise the instructions which, when executed on at least one processor, cause the at least one processor to carry out the actions described herein, as performed by the processing unit 12. In some embodiments, the computer-readable storage medium may be a transitory or a non-transitory computer-readable storage medium.

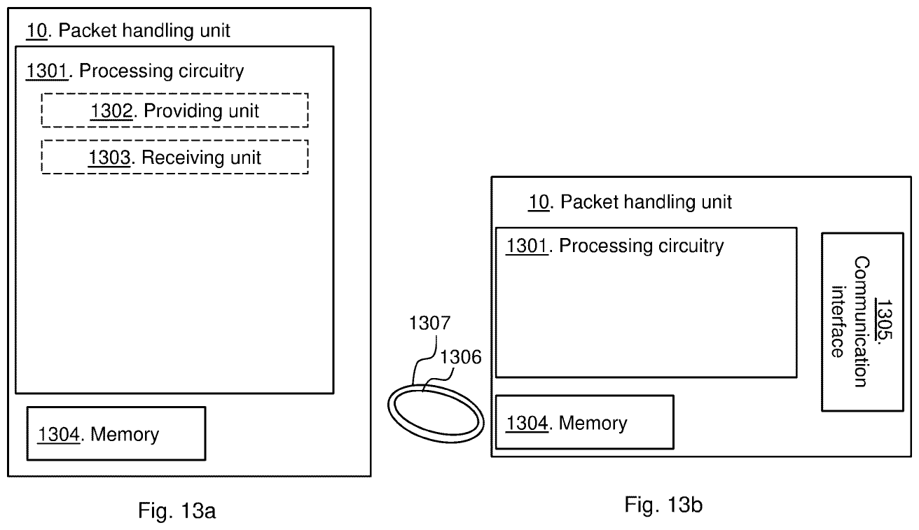

FIGS. 13a-b are schematic overviews of the packet handling unit 10 comprising two or more RX queues for handling packets in the communication network according to embodiments herein.

The packet handling unit 10 may comprise processing circuitry 1301, e.g. one or more processors, configured to perform the methods herein. The processing circuitry 1301 may be arranged in one stand-alone unit or be distributed among a number of servers or units.

The packet handling unit 10 may comprise a providing unit 1302, e.g., a writer, a transmitter or transceiver. The packet handling unit 10, the processing circuitry 1301, and/or the providing unit 1302 is configured to provide the indication to the processing unit, wherein the indication indicates the status of the RX queue out of the two or more RX queues. The status indicated may indicate the availability of packets and/or the relevance of packets in the RX queue. The packet handling unit 10, the processing circuitry 1301, and/or the providing unit 1302 may be configured to provide the indication by receiving the monitoring instruction or configuring the probe register bits keeping track of the two or more RX queues associated with one or more processing units at the packet handling unit 10.

The packet handling unit 10 may comprise a receiving unit 1303, e.g., a reader, a receiver or transceiver. The packet handling unit 10, the processing circuitry 1301, and/or the receiving unit 1303 is configured to receive, from the processing unit 12, the polling of the one or more packets from the RX queue.

The packet handling unit 10 comprises a memory 1304. The memory 1304 comprises one or more units to be used to store data on, such as indications, status information, packets, actions, resource information, data related to nodes, and applications to perform the methods disclosed herein when being executed, and similar. Thus, embodiments herein may disclose a packet handling unit 10 comprising two or more RX queues for handling packets in the communication network, wherein the packet handling unit 10 comprises processing circuitry and a memory, said memory comprising instructions executable by said processing circuitry whereby said packet handling unit 10 is operative to perform any of the methods herein. Furthermore, the packet handling unit 10 may comprise a communication interface 1305 comprising, e.g., a transmitter, a receiver and/or a transceiver.

The methods according to the embodiments described herein for the packet handling unit 10 are respectively implemented by means of e.g. a computer program product 1306 or a computer program, comprising instructions, i.e., software code portions, which, when executed on at least one processor, cause the at least one processor to carry out the actions described herein, as performed by the packet handling unit 10. The computer program product 1306 may be stored on a computer-readable storage medium 1307, e.g., a disc, a universal serial bus (USB) stick or similar. The computer-readable storage medium 1307, having stored thereon the computer program product, may comprise the instructions which, when executed on at least one processor, cause the at least one processor to carry out the actions described herein, as performed by the packet handling unit 10. In some embodiments, the computer-readable storage medium may be a transitory or a non-transitory computer-readable storage medium.

In some embodiments a more general term “network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), IoT capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to communication technology such as any RAT or multi-RAT systems, where the UE receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a radio network node or UE, for example.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. (canceled)

2. A method performed by a processing unit (12) for handling packets in a communication network (1), the method comprising
obtaining (501) an indication from a packet handling unit (10) comprising two or more receive, RX, queues, wherein the indication indicates a status of a RX queue out of the two or more RX queues; and
selecting (502) at least one RX queue out of the two or more RX queues to poll one or more packets from based on the obtained indication.

3. The method according to claim 2, wherein obtaining the indication comprises probing the status of the two or more RX queues.

4. The method according to claim 2, wherein obtaining the indication comprises configuring monitoring instruction or configuring probe register bits keeping track of the two or more RX queues associated with one or more processing units at the packet handling unit (10).

5. The method according claim 2, further comprising
polling (503) the one or more packets from the selected at least one RX queue.

6. The method according to claim 2, wherein the status indicated indicates availability of packets and/or relevance of packets and selecting the at least one RX queue is based on the availability of packets and/or relevance of packets.

7. The method according to claim 2, wherein selecting the at least one RX queue is further based on a preference of an application or user of the application.

8. A method performed by a packet handling unit (10) comprising two or more receive, RX, queues for handling packets in a communication network, the method comprising:
providing (601) an indication to a processing unit (12), wherein the indication indicates a status of a RX queue out of the two or more RX queues.

9. The method according to the claim 8, wherein the status indicated indicates availability of packets and/or relevance of packets in the RX queue.

10. The method according to claim 8, further comprising
receiving (602), from the processing unit (12), a polling of one or more packets from a RX queue.

11. The method according to claim 8, wherein providing the indication comprises receiving a monitoring instruction or configuring probe register bits keeping track of the two or more RX queues associated with one or more processing units at the packet handling unit (10).

12. (canceled)

13. A computer-readable storage medium, having stored thereon a computer program product comprising instructions which, when executed on at least one processor, cause the at least one processor to carry out the methods according to claim 1.

14. (canceled)

15. A processing unit (12) for handling packets in a communication network, wherein the processing unit (12) is configured to:
obtain an indication from a packet handling unit (10) comprising two or more receive, RX, queues, wherein the indication indicates a status of a RX queue out of the two or more RX queues; and
select at least one RX queue out of the two or more RX queues to poll one or more packets from based on the obtained indication.

16. The processing unit (12) according to claim 15, wherein the processing unit (12) is configured to obtain the indication by probing the status of the two or more RX queues.

17. The processing unit (12) according to claim 15, wherein the processing unit (12) is configured to obtain the indication by configuring monitoring instruction or configuring probe register bits keeping track of the two or more RX queues associated with one or more processing units at the packet handling unit (10).

18. The processing unit (12) according to claim 15, wherein the processing unit (12) is further configured to poll the one or more packets from the selected at least one RX queue.

19. The processing unit (12) according to claim 15, wherein the status indicated indicates availability of packets and/or relevance of packets, and wherein the processing unit is configured to select the at least one RX queue based on the availability of packets and/or relevance of packets.

20. The processing unit (12) according to claim 15, wherein the processing unit (12) is configured to select the at least one RX queue further based on a preference of an application or user of the application.

21-24. (canceled)
